(19) United States
(12) Patent Application Publication
(10) Pub. No.: US 2013/0186869 A1
(43) Pub. Date: Jul. 25, 2013

(54) COUPLER INSTALLATION DEVICE

(71) Applicant: CSX Transportation, Jacksonville, FL (US)

(72) Inventor: Marlin L. MATTHEWS, JR., St. Augustine, FL (US)

(73) Assignee: CSX Transportation, Jacksonville, FL (US)

(21) Appl. No.: 13/747,210

(22) Filed: Jan. 22, 2013

Related U.S. Application Data
(60) Provisional application No. 61/589,768, filed on Jan. 23, 2012.

(51) Int. Cl. B25D 1/16; B23K 11/34; B23P 11/02

(52) U.S. Cl. CPC B25D 1/16; B23P 11/02; B23K 11/34
USPC 219/117.1; 81/463; 29/525

(57) ABSTRACT

A device comprises a frame, a plurality of fingers, and an integrated slide hammer to drive a coupler onto a first pipe. The device may drive the coupler backwards onto a second pipe. The device may position the coupler for fusion without having to remove the device for the backward driving of the coupler. The device may be used above ground or in a trench.

### CROSS REFERENCE TO PRIOR APPLICATION

This application claims priority to and the benefit thereof from U.S. provisional patent application No. 61/589,768, filed Jan. 23, 2012, titled “Electro Fusion Coupler Installation Device,” the entirety of which is hereby incorporated herein by reference.

### FIELD OF THE DISCLOSURE

The present disclosure relates to a device that may be implemented to install, e.g., a high-density polyethylene (HDPE) electro fusion pipe coupler, or any other type of coupler onto a pipe, a rod, or the like.

### BACKGROUND OF THE DISCLOSURE

An existing process requires the use of a 2″×4″ wood and a sledge hammer to install couplers on to pipes. However, this process can result in serious injury to person(s) installing the couplers on to the pipes. For example, an installer's hand may be hit by the sledge hammer.

The disclosure includes a novel device that may be utilized in the safe installation of couplers, such as, e.g., electro fusion couplers, or the like.

### SUMMARY OF THE DISCLOSURE

According to one non-limiting example of the disclosure, a device comprises a frame, a plurality of fingers, and an integrated slide hammer to drive a coupler onto pipe. The device may be implemented to also drive the coupler onto a second pipe by, for example, first driving the coupler onto a first pipe and then backwards onto a second pipe. The device may be implemented to properly position the coupler on one or more pipes for fusion without having to remove the device for reversal. The device may be used above ground or in a trench.

According to an aspect of the disclosure, a device is provided for installing a coupler onto a pipe. The device comprises: a main plate that is configured to engage and drive a portion of a first transverse surface of the coupler in a first direction; a stop plate that is configured to engage and drive a portion of a second transverse surface of the coupler that is opposite the first transverse surface in a second direction that is opposite the first direction; a guide that is coupled to the main plate and the stop plate; and a hammer that is slidably affixed to the guide and configured to slide between the main plate and the stop plate, wherein the main plate comprises a body and a plurality of fingers that are configured to form an open section.

The device may further comprise a handle portion. The handle portion may positioned at an angle with respect to a longitudinal axis of the guide. The angle may be about 135°.

The main plate may comprise the handle portion.

The stop plate may comprise the handle portion.

The hammer may comprise an off-center channel.

The device may further comprise an impact member configured to dampen a noise that results from the impact of the hammer. The impact member may comprise a leather pad or a rubber pad.

According to a further aspect of the disclosure, a device is provided for installing a coupler onto a pipe, the device comprising: a main plate that is configured to engage and drive a portion of a transverse surface of the coupler toward the pipe; a guide that is coupled to the main plate; and a hammer that is slidably affixed to the guide and configured to apply a force to the main plate to drive the coupler onto the pipe.

The main plate may comprise a pipe guide portion having a plurality of fingers. The plurality of fingers may be configured to form an open section.

At least one of the plurality of fingers may be configured to rest on a portion of a surface of the coupler.

The pipe guide portion may comprise a body that is configured to engage and drive the transverse surface of the coupler toward the pipe. The body may comprise an opening having a diameter that is greater than a diameter of the pipe.

According to a still further aspect of the disclosure, a method is provided for installing a coupler onto a pipe. The method comprises: mounting a device with an integrated hammer on the coupler; sliding a hammer in the device along a guide in a direction toward the pipe; and impacting the hammer against a plate to engage and drive the coupler onto the pipe.

The method may further comprise sliding the hammer in the device along the guide in a direction substantially opposite said direction toward the pipe. The method may further comprise impacting the hammer against a second plate to engage and drive the coupler onto a second pipe.

The method may comprise applying an electric current to the coupler to fuse the coupler to the pipe.

Additional features, advantages, and embodiments of the disclosure may be set forth or apparent from consideration of the detailed description, drawings and attachment. Moreover, it is to be understood that the foregoing summary of the disclosure and the following detailed description and drawings are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced In the drawings:

FIG. 1 shows a device that is configured according to an embodiment of the disclosure;

FIG. 2 shows a side view of the device of FIG. 1;

FIG. 3 shows a device that is configured according to another embodiment of the disclosure;

FIG. 4 shows a side view of the device of FIG. 3; and

FIG. 5 shows an example of a process for installing a coupler onto a pipe using the device of FIG. 1 or FIG. 3, according to the principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

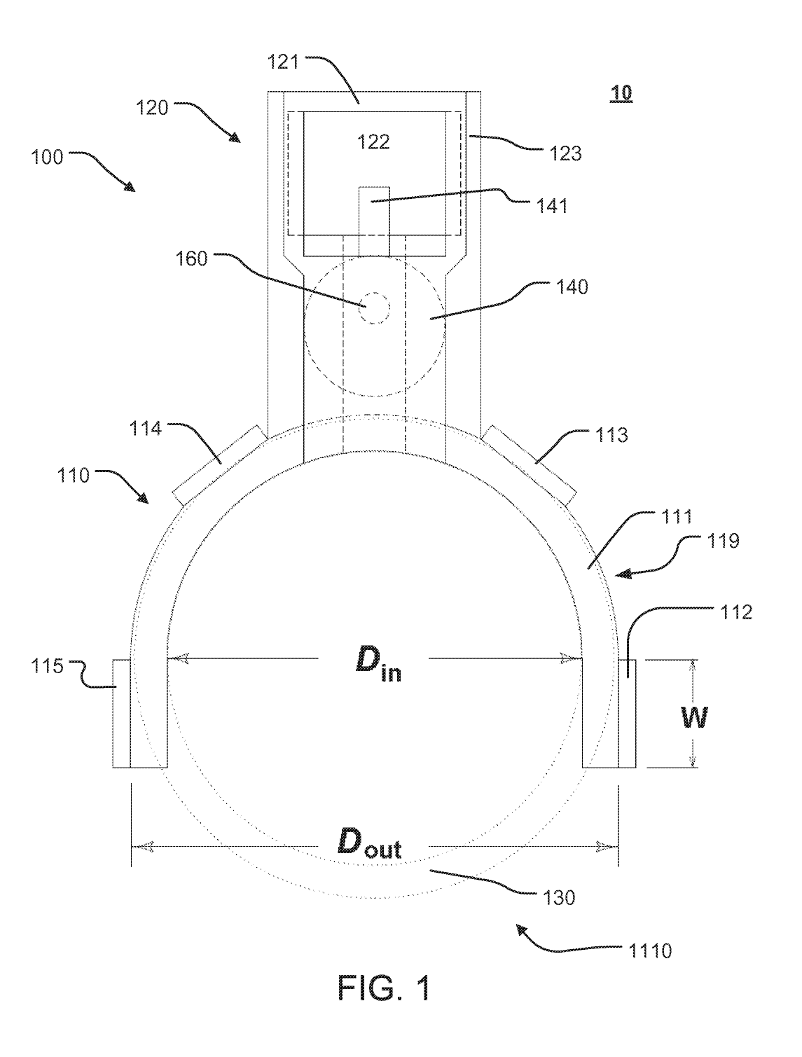

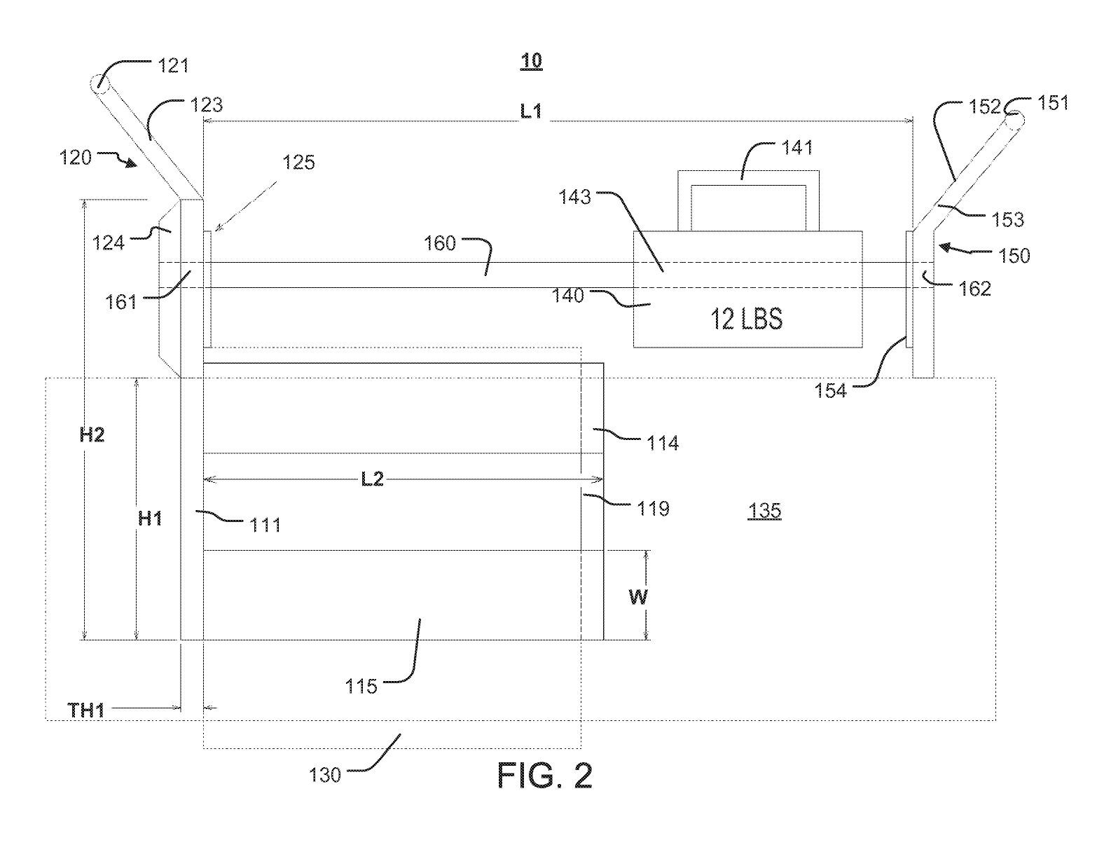

FIG. 1 shows a first embodiment of a device 10 that is configured according to the principles of the disclosure. FIG. 2 shows a side view of the device 10.

Referring to FIGS. 1 and 2, the device 10 comprises a main plate 100, a plurality of fingers 112, 113, 114, 115, a hammer 140, a stop plate 150, and a guide (e.g., a rod, a pipe, or the like) 160. The device 10 may further include one or both of a pair of impact members 125, 154 (shown in FIG. 2). The device 10 may be implemented to apply a force to a first transverse surface of a coupler 130, as seen in FIG. 1, and drive the coupler 130 onto, e.g., a pipe 135 (shown in FIG. 2). The device 10 may be implemented to also apply a force to a second opposite transverse surface of the coupler 130 and drive the coupler 130 in the opposite direction onto a second pipe (not shown) that may be inserted into the other end of the coupler 135 through the opening in the main plate 100.

The main plate 100 may include a pipe guide portion 110 and a grip portion 120. The pipe guide portion 110 and grip portion 120 may be formed integrally as a single piece, or may be formed from two or more pieces that are coupled, connected, affixed, fused, adhered, glued, and/or welded together to form a single piece. The pipe guide portion 110 and/or the grip portion 120 may be made from a material such as, e.g., a metal, a plastic, a carbon-fiber, or the like.

The pipe guide portion 110 may include a body 111 having an inner diameter Dᵢₙ and an outer diameter Dₒᵤₜ. The inner Dᵢₙ diameter is configured to be greater than the outer diameter of the pipe (not shown) that is to be inserted into the coupler 130. The body 111 may have a shape such as, e.g., a circle, a semi-circle, an ellipse, a square, a rectangle, or any other shape that may align with a transverse surface of the coupler 130 that is to be affixed onto, e.g., a pipe, a rod, or the like. In the example in FIG. 1, the body 111 has a semi-circular, U-shape that is selected for implementation with a cylindrical coupler 130, which has an opening 1110 that is configured to allow for removal of the device 10 after, e.g., the coupler 130 has been affixed to pipes at both ends of the coupler 130.

According to an alternative embodiment of the disclosure, the body 111 may be configured to form a complete circle (without an opening 1110), which may align with the transverse surface of the coupler 130 to provide and distribute an impact force provided by, e.g., sliding and impacting the hammer 140 against the impact member 154 (shown in FIG. 2).

The pipe guide portion 110 may include the plurality of fingers 112, 113, 114, 115, which may be spaced apart (e.g., as seen in FIG. 1) to provide one or more open sections 119 between a pair of adjacent fingers. The one or more open sections 119 may allow for one or more electrodes to be accessible during operation of the device 10. Furthermore, electrical wiring (not shown) may be coupled to, e.g., a pair of electrodes (not shown) in the coupler 130 and allowed to remain connected during installation and operation of the device 10.

The plurality of fingers 112, 113, 114, 115, may be formed integrally with the body 111, or the fingers may be coupled, connected, affixed, fused, adhered, glued, and/or welded to the body 111. The fingers may be provided on, or along the outer surface of the body 111, as seen in FIG. 1. The fingers 112, 113, 114, 115 may each have substantially the same width W, or the fingers may have different widths. Further, the fingers 112, 113, 114, 115 may each have substantially the same length L2 (shown in FIG. 2) or the fingers may have different lengths. The length L2 may be shorter than the length of the coupler 130. Furthermore, the length L2 may be shorter than the distance L1 between the main plate 100 and the stop plate 150. The device 10 may be configured to have a length L1 that is great than the length of the coupler 130.

The grip portion 120 may include a handle portion 123, which may comprise a handle 121. The handle portion 123 may further comprise an opening 122 to allow a user to pass his fingers through the opening and securely grasp the handle 121. The handle portion 123 may be configured to have an angle (e.g., between about 90° and about 270°) with respect to the longitudinal axis of the guide 160. For instance, as seen in FIG. 2, the handle portion 123 may be configured to have an angle of about 135° with respect to the longitudinal axis of the guide 160. The handle 121 may be provided with, e.g., a coating or a grip, which may be made of an elastic material, such as, e.g., rubber, high density foam, or the like, to reduce transfer of impact energy from the device 10 to the user during operation of the device 10.

The grip portion 120 may include an opening 161 that is configured to receive and hold a first end of the guide 160. The grip portion 120 may further include a guide lock 124. The guide lock 124 may be formed integrally with the grip portion 120. The guide lock 124 may be configured to receive and securely hold in place the first end of the guide 160. The guide lock 124 may include an opening (not shown) to allow a portion of the first end of the guide 160 to pass through the guide lock 124 and allow a fastening mechanism (such as, e.g., a bolt, a nut, a screw, a clip, a pin, or the like) to be attached to the portion of the first end of the guide 160 to secure the guide 160 to the grip portion 120.

Alternatively, the guide lock 124 may be integrally formed with or connected to the guide 160. In this case, the second end of the guide 160 may be inserted through the opening 161 in the grip portion 120 and passed through the grip portion 120 until a first surface of the guide lock 124 contacts the grip portion 120. The stop plate 150 may then be affixed to a portion of the second end of the guide 160.

As seen in FIG. 2, the main plate 100 may be configured to have a height H1 from a lowest edge of the U-shaped body 111 to the highest point of the opening formed by the body 111, which may be configured to rest near the outer surface of a second pipe (not shown) that may be inserted into the coupler 130, opposite the pipe 135. Further, the main plate 100 may be configured to have a height H2 from the lowest edge of the U-shaped body 111 to the handle portion 123. The main plate 100 may have a thickness TH1. According to an embodiment of the disclosure, the device 10 may have the following dimensions:
Dᵢₙ=8.625″
Dₒᵤₜ=10.875″
H1=6.313″
H2=12″
L1=22″
L2=8.533″
TH1=0.5″
W=1.5″
   The device 10 may be configured to have larger or smaller dimensions, which may be configured to have proportions that are consistent with (or not consistent with) the relationships provided above. For instance, a device may be configured to have an outer diameter of Dₒᵤₜ and an inner diameter Dᵢₙ, where the relationship between the diameters may be expressed by the following equation Dₒᵤₜ=C·Dᵢₙ, where C may equal, e.g., 87/69, or about 1.26. Similarly, the ratios of H1:H2 and L1:L2, or the ratios of any of the dimensions may be consistent with the values provided above.

The stop plate 150 may include a handle portion 153, which may comprise a handle 1151. The handle portion 153 may further comprise an opening 152 to allow the user to pass his fingers through the opening and securely grasp the handle 152. The handle portion 153 may be configured to form an angle of, e.g., between about 90° and about 270° with the longitudinal axis of the guide 160. For instance, as seen in FIG. 2, the handle portion 153 may be configured to have an angle of about 45° with respect to the longitudinal axis of the guide 160. The handle 151 may be provided with, e.g., a coating or a grip, which may be made of an elastic material, such as, e.g., rubber, high density foam, or the like, to reduce transfer of impact energy from the device 10 to the user during operation of the device 10. The stop plate 150 may further include an opening 162 that is configured to receive and hold a second end of the guide 160.

According to an embodiment of the disclosure, the stop plate 150 may include a semi-circular U-shaped body (not shown) having an inner diameter Dᵢₙ.

During operation, the stop plate 150 may be configured to rest near or on top of the pipe 135. Further, the stop plate 150 may be configured to engage and apply a force against the transverse surface of the coupler 130, thereby moving the coupler 130 in a direction away from the pipe 135, so as to, e.g., remove the coupler 130 off of the pipe 130 or to move a portion of the coupler 130 off of the pipe 135 on to the second pipe (not shown).

Referring to FIG. 2, the hammer 140 may be slidably mounted and guided longitudinally on the guide 160, between the main plate 100 and the stop plate 150. The hammer 140 may be drilled (or formed) off-center to provide a channel (or opening) that facilitates self-alignment of the hammer 140. For instance, as seen in FIG. 2, the channel (or opening) 143 may be formed (or drilled) in the hammer 140 (through which the guide 160 is inserted) away from the longitudinal, center axis of the hammer 140 and closer to the handle 141, so that the hammer 140 may self-align with gravity to position and maintain the handle 141 in, e.g., an upper position that is substantially aligned with gravitational pull.

The hammer 140 may include one or more guides, including, for example, bearings to minimize friction when the hammer 140 travels along the guide 160. The hammer 140 may include, for example, a 2 lb weight, a 5 lb weight, a 10 lb weight, a 12 lb weight, or any other weight.

The device 10 may be configured to ensure that the hammer 140 cannot contact, e.g., a coupler electrode located in an open section 119.

The guide 160 may be configured to be substantially perpendicular to the main plate 100 and/or stop plate 150.

The impact members 125, 154 may be made of a durable material, such as, e.g., rubber, leather, foam, or the like. The impact member 125, 154 may function to, e.g., dampen noise during operation of the device 10, as the hammer 140 is impacted against either the main plate 100 or the stop plate 150.

All of the edges in the device 10 may be configured to have softened edges (e.g., a radius of ⅛″, or greater) and all of the edges may be finished smooth. The device 10 may be configured to have a total weight that allows the user to readily early and manipulate the device. The device 10 may have a total weigh of e.g., 30 lbs, or less. The device 10 may weigh more than 30 lbs.

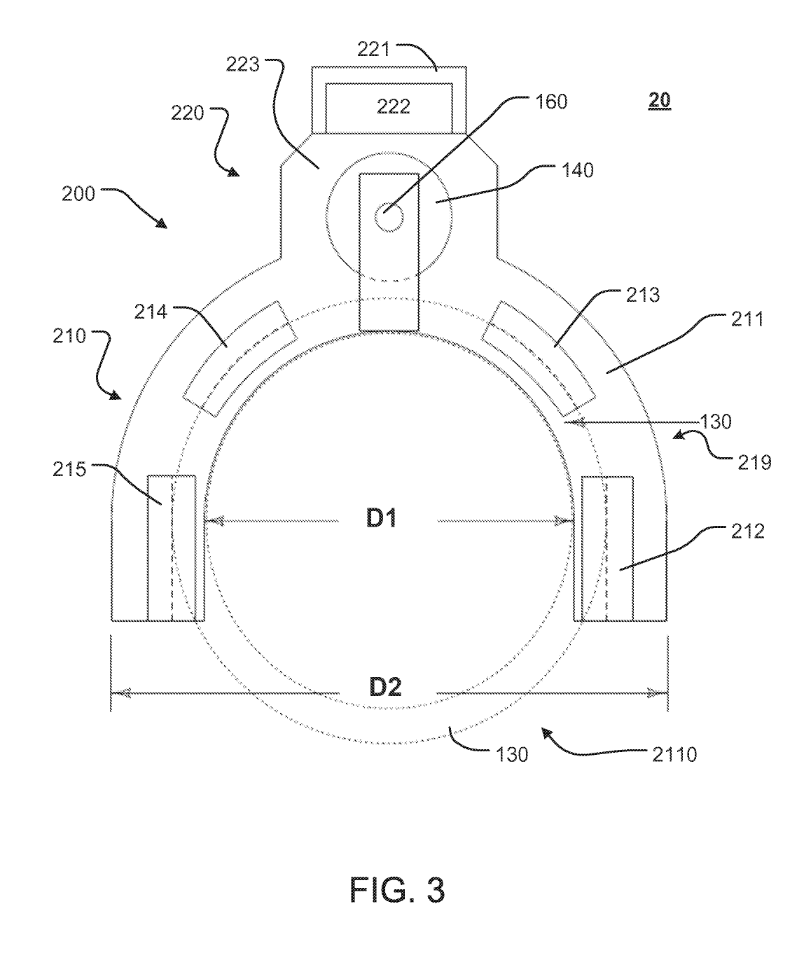

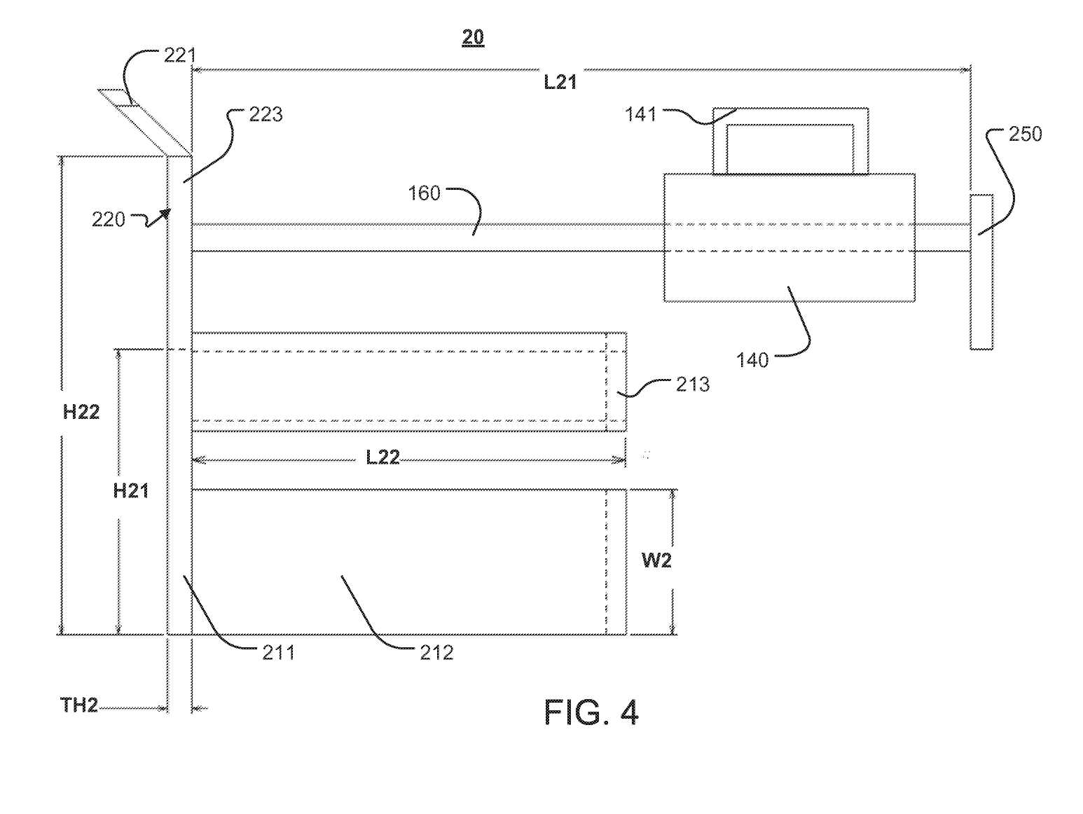

FIG. 3 shows a device 20 that is configured according to a second embodiment of the disclosure. FIG. 4 shows a side view of the device 20.

Referring to FIGS. 3 and 4, the device 20 comprises a main plate 200, a plurality of fingers 212, 213, 214, 215, the hammer 140, a stop plate 250, and the guide 160. The device 20 may further include one or both of a pair of impact members 125, 154 (shown in FIG. 2). The device 20 may be implemented in a similar manner to the device 10.

The main plate 200 may include a pipe guide portion 210 and a grip portion 220. The pipe guide portion 210 and grip portion 220 may be formed integrally as a single piece, or may be formed from two or more pieces that are coupled, connected, affixed, fused, adhered, glued, and/or welded together to form a single piece. The pipe guide portion 210 and/or the grip portion 220 may be made from a material such as, e.g., a metal, a plastic, a carbon-fiber, or the like.

The pipe guide portion 210 may include a body 211 having an inner diameter D1 and an outer diameter D2. The body 211 may have a shape such as, e.g., a circle, a semi-circle, an ellipse, a square, a rectangle, or any other shape that may align with a transverse surface of the coupler 130. In the example in FIG. 3, the body 211 has a semi-circular U-shape that is selected for implementation with a cylindrical coupler 130, which has an opening 2110 that is configured to allow for removal of the device 20 after, e,g., the coupler 130 has been affixed to pipes at both ends of the coupler 130.

The pipe guide portion 210 may include the plurality of fingers 212, 213, 214, 215, which may be spaced apart (e.g., as seen in FIGS. 3, 4) to provide one or more open sections 219 between a pair of adjacent fingers. The one or more open sections 219 may allow for one or more electrodes to be accessible during operation of the device 20, as discussed above with respect to device 10.

The plurality of fingers 212, 213, 214, 215, may be formed integrally with the body 211, or the fingers may be coupled, connected, affixed, fused, adhered, glued, and/or welded to the body 211. The fingers 212, 213, 214, 215 may each have substantially the same width W2, or the fingers may have different widths. Further, the fingers 212, 213, 214, 215 may each have substantially the same length L22 (shown in FIG. 4) or the fingers may have different lengths. The length L22 may be shorter than the length of the coupler 130. Furthermore, the length L22 may be shorter than the distance L21 between the main plate 200 and the stop plate 250. The length L21 should be greater than the length of the coupler 130.

The grip portion 220 may include a handle portion 223, which may comprise a handle 221. The handle portion 223 may be configured to have an angle (e.g., between about 90° and about 270°) with respect to the longitudinal axis of the guide 160. For instance, as seen in FIG. 4, the handle portion 223 may be configured to have an angle of about 135° with respect to the longitudinal axis of the guide 160. The handle 221 may be provided with, e.g., a coating or a grip, which may be made of an elastic material, such as, e.g., rubber, high density foam, or the like, to reduce transfer of impact energy from the device 10 to the user during operation of the device 20. The grip portion 220 may include an opening (not shown) that is configured to receive and hold a first end of the guide 160.

As seen in FIG. 4, the main plate 200 may be configured to have a height H21 from a lowest edge of the U-shaped body 211 to the highest point of the opening formed by the body 211, which may be configured to near (or on) an outer surface of a second pipe (not shown) that may be inserted into the coupler 130, which is opposite the pipe on (or near) which the stop plate 250 may rest during operation of the device 20. Further, the main plate 200 may be configured to have a height 1122 from the lowest edge of the U-shaped body 211 to the handle portion 223. The main plate 200 may have a thickness TH2. According to an embodiment of the disclosure, the device 20 may have the following dimensions:
D1=8.625″
D2=12.875″
H21=6.313″
H22=12″
L21=22″
L22=8.533″
TH2=0.75″
W2=3″
   The device 20 may be configured to have larger or smaller dimensions, which may be configured to have proportions that are consistent with (or not consistent with) the relationships provided above. For instance, a device may be configured to have an outer diameter of D2 and an inner diameter D1, where the relationship between the diameters may be expressed by the following equation D2=C2·D1, where C2 may equal 101/69, or about 1.46. Similarly, the proportions of H21:H22 and L21:L22, or the proportions of any of the dimensions may be consistent (or not consistent) with the proportions of the exemplary values provided above.

The stop plate 250 may be configured to be substantially perpendicular with the longitudinal axis of the guide 160. The stop plate 250 may include an opening (not shown) that is configured to receive and hold a second end of the guide 160. During operation, the stop plate 250 may be configured to rest atop of one pipe, while the main plate 200 may rest atop of the other pipe being coupled by the coupler 130.

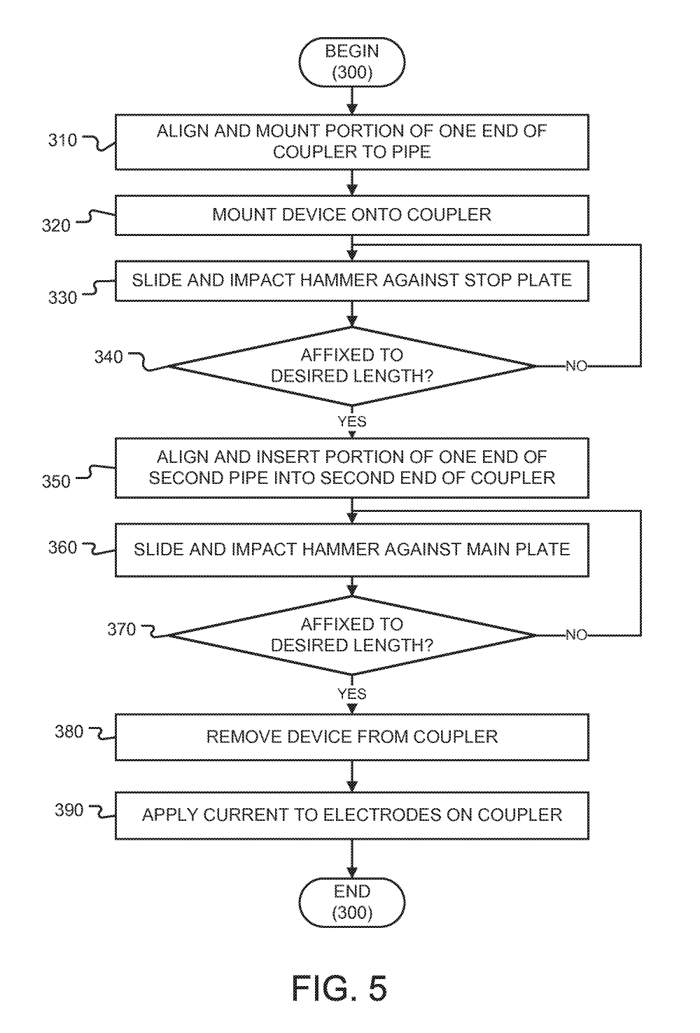

FIG. 5 shows an example of a process 300 for installing the coupler 130 onto the pipe 135 using the device 10 (or 20), according to the principles of the disclosure. Referring to FIGS. 1 and 5, the coupler 130 may be aligned with an end of the pipe 135 (shown in FIG. 2) such that the end of the pipe 135 may be inserted into the coupler 130 (Step 310). In order to facilitate proper alignment, an edge of the end of the pipe 135 may be inserted into the opening of the coupler 130 (Step 310) before the device 10 is used to drive the coupler 130 on to the pipe 135.

The device 10 may be mounted onto the coupler 10 (Step 320). If the coupler includes, e.g., a pair of electrodes (not shown), the device 10 may be positioned so that the electrodes are provided in the open section 119 (or 219) between fingers 112, 113, 114, 115 (or fingers 212, 213, 214, 215). The stop plate 150 (250) of the device 10 (20) may be placed on top of the pipe 135.

After the device 10 is mounted and properly aligned with the coupler 130, a user may grip the handle 141 with one hand and the handle 121 (or 151) with the other hand, and slide the hammer 140 toward and against the stop plate 150 (250) (Step 330). If the user desires to move the coupler 130 away from (or off of) the pipe 135, the user may slide and impact the hammer 140 against the main plate 100 (200), thereby causing the stop plate 150 (250) to engage and apply a force against the opposite end of the coupler 130.

A determination may be made whether the coupler 130 is affixed in a desired location on the pipe 135 (Step 340). If a determination is made that the coupler 130 should be moved further onto (or off of) the pipe 135 (NO at Step 340), then the hammer 140 may be repeatedly slid and impacted against the stop plate 150 (250) (Step 330) until it is determined that the coupler 130 is properly mounted onto the pipe 135 (YES at Step 340). For instance, the coupler 130 may be properly mounted onto the pipe 135 when the coupler 130 is substantially completely mounted on the pipe 135. The user may leave a small lip portion of the coupler 130 non-mounted on the pipe 135, so as to facilitate proper alignment and partial insertion of a second pipe into the coupler 130.

An end of the second pipe may be aligned with the opposite (second) opening in the coupler 130 (not shown) (Step 350). A portion of the end of the second pipe may be inserted into the second end of the coupler 130 (Step 350). The hammer 140 may be slid and impacted against the main plate 100 (Step 360). In this step, the stop plate 150 (250) may engage and apply a force against the transverse surface of the coupler 130, on the side of the pipe 135, driving the coupler 130 away from the pipe 135 and onto the second pipe.

A determination may be made whether the coupler 130 is properly positioned onto both the pipe 135 and the second pipe (Step 370). If a determination is made that the coupler 130 should be moved further onto (or off of) the second pipe (NO at Step 370), then the hammer 140 may be repeatedly slid and impacted against the main plate 100 (200) (Step 360) until it is determined that the coupler 130 is properly mounted onto the pipe 135 and the second pipe (YES at Step 370). For instance, the coupler 130 may be determined to be properly mounted when the coupler 130 is spaced substantially equally on the ends of the pipe 135 and the second pipe.

The device 10 (20) may be removed from the coupler and pipe(s) (Step 380).

If the coupler 130 is an electrofusion coupler, then a current may be applied to the electrodes on the coupler 130 to cause the coupler 130 to fuse to the pipe 135 and the second pipe (not shown) (Step 390). If the coupler 130 is not an electrofusion coupler, or the like, then this step may be skipped.

It is noted that the device 10 (20) may be automated. In which case the process 300 may be carried out under the control of a computer.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A device for installing a coupler onto a pipe, the device comprising:
a main plate that is configured to engage and drive a portion of a first transverse surface of the coupler in a first direction;
a stop plate that is configured to engage and drive a portion of a second transverse surface of the coupler that is opposite the first transverse surface in a second direction that is substantially opposite the first direction;
a guide that is coupled to the main plate and the stop plate; and
a hammer that is slidably affixed to the guide and configured to slide between the main plate and the stop plate,
wherein the main plate comprises:
a body having an opening; and
a plurality of fingers comprising a pair of adjacent fingers that are configured to form an open section.

2. The device of claim 1, further comprising:
a handle portion.

3. The device of claim 2, wherein the handle portion is positioned at an angle with respect to a longitudinal axis of the guide.

4. The device of claim 3, wherein the angle is about 135°.

5. The device of claim 2, wherein the main plate comprises the handle portion.

6. The device of claim 2, wherein the stop plate comprises the handle portion.

7. The device of claim 1, wherein the hammer comprises an off-center channel.

8. The device of claim 1, further comprising:
an impact member configured to dampen a noise that results from the impact of the hammer.

9. The device of claim 8, wherein the impact member comprises:
a leather pad; or
a rubber pad.

10. A device for installing a coupler onto a pipe, the device comprising:
a main plate that is configured to engage and drive a portion of a transverse surface of the coupler toward the pipe;
a guide that is coupled to the main plate; and
a hammer that is slidably affixed to the guide and configured to apply a force to the main plate to drive the coupler onto the pipe.

11. The device of claim 10, wherein the main plate comprises a pipe guide portion having a plurality of fingers.

12. The device of claim 11, wherein the plurality of fingers comprise at least two fingers that are configured to form an open section.

13. The device of claim 11, wherein the pipe guide portion comprises a body that is configured to engage and drive the transverse surface of the coupler toward the pipe.

14. The device of claim 11, wherein at least one of the plurality of fingers is configured to rest on a portion of a surface of the coupler.

15. The device of claim 13, wherein the body comprises an opening having a diameter that is greater than a diameter of the pipe.

16. A method for installing a coupler onto a pipe, the method comprising:
mounting a device with an integrated hammer on the coupler;
sliding a hammer in the device along a guide in a direction toward the pipe; and
impacting the hammer against a plate to engage and drive the coupler onto the pipe.

17. The method of claim 16, further comprising:
sliding the hammer in the device along the guide in a direction substantially opposite said direction toward the pipe.

18. The method of claim 17, further comprising:
impacting the hammer against a second plate to engage and drive the coupler onto a second pipe.

19. The method of claim 16, further comprising:
applying an electric current to the coupler to fuse the coupler to the pipe.

20. The method of claim 18, further comprising:
applying an electric current to the coupler to fuse the coupler to the pipe and the second pipe.
